(19) United States
(12) Patent Application Publication
(10) Pub. No.: US 2010/0192870 A1
(43) Pub. Date: Aug. 5, 2010

(54) Airline Pet Carrier Having Integral Retractable Wheels and a Smooth Exterior

(76) Inventor: Anthony Wood, Woodbridge, VA (US)

Correspondence Address: JAMES W. PRAVEL;PRAVEL INTELLECTUAL PROPERTY LAW, PC, 1800 DIAGONAL ROAD, SUITE 600, ALEXANDRIA, VA, 22314, US

(21) Appl. No.: 12/365,226

(22) Filed: Feb. 4, 2009

(51) Int. Cl. A01K 1/00; B23P 11/00

(52) U.S. Cl. 119/496; 29/428

(57) ABSTRACT

An airline approved pet carrier includes retractable wheels that leave the exterior surface of the carrier smooth. Other components of the carrier are positioned in a recess in the carrier to maintain a smooth exterior surface. The wheels are quick to deploy and include a positive mechanism to keep them in the stowed and the deployed positions.

### CROSS REFERENCE TO RELATED APPLICATIONS

Not applicable.

### BACKGROUND

1. Field of the Invention

This invention relates to portable pet carriers generally and pet carriers that can be transported on airlines in particular.

2. Background of the Invention

Everyday more and more people are choosing to travel with their pets rather than leaving them at home. Our dogs are part of the family, and are considered by many to be as important as children. It was not that long ago that it would be rare to see a dog or cat traveling by airlines. Today however, in almost any airport in the country, you will see someone with his or her dog in tow. Subject to specific regulations, small pets may be carried onto the airplane to remain with the owner for the duration of the flight. Larger pets, usually dogs, must be transported in the cargo section of the plane and the pet carrier must be handled by airline cargo handling personnel.

When a person moves the pet carrier about the airport, for example from the entrance of the airport to the airline baggage check location, the pet carrier must generally be rolled because it is too heavy to carry. U.S. Pat. No. 5,701,843 and U.S. Design Pat. D566,907 show pet carriers having a plurality of wheels on which the carrier can be rolled. Alternatively, pet carriers that do not have wheels are generally rolled about on a cart or dolly that does have wheels.

Significant problems can occur when wheels or other items that are attached to the pet carrier get caught on other freight items or conflict with irregular surfaces in the freight area. When extended wheels catch on other freight items, such as other pet carriers or other items of freight, it can cause the pet carrier to topple over and can jeopardize the life of the pet. Retractable wheels do exist for luggage, for example U.S. Pat. Nos. 2,439,660; 2,581,417 and 5,154,265. However, existing retractable wheels are not suited for use with pet carriers, and they are overly complex. U.S. Pat. No. 5,253,612 also shows a pet carrier having retractable wheels, but they extend beyond the outer surface of the carrier, even when they are retracted.

### BRIEF SUMMARY OF THE INVENTION

What is needed is an airline approved pet carrier that includes retractable wheels that leave the exterior surface of the carrier smooth and free of obstructions. Any other components of the carrier can be positioned in a recess in the carrier to maintain a smooth exterior surface. The wheels can be quick to deploy and may include a positive mechanism to keep them in the stowed and the deployed positions.

The inventive airline compatible pet carrier comprises an upper and a lower half. A plurality of wheels are attached to rotating wheel support members. The rotating support members are mounted to a lower region of the lower half. The lower region is proximate to a lower edge of the lower half. The wheels are positioned within a recess in the lower region of the lower half. The rotating wheel support members are secured in an upward and a downward position whereby each of the wheels are alternately secured in an upward, stowed position and a downward, deployed position. The wheel support members can have a pin end, which protrudes into a socket positioned in the recess of the lower region of the lower half of the pet carrier. The socket can be integral with an insert that is attached to the lower half of the pet carrier. The pin ends of the wheel support members have a plurality of slots that engage at least one key in each of the sockets, wherein at least one of the slots engages at least one key when the wheel support member is in an upward, stowed position and at least on of the slots of the pin end of the wheel support member engages another of the at least one key when the wheel support is in a downward, deployed position.

Sliding panels may be included to contain the rotating support members and wheels so that the entire outer surface of the pet carrier remains smooth to avoid conflicting with other pet carriers, freight items, or other obstructions during transport.

A removable disposable or reusable moisture absorbent liner can be secured to the inner floor of the lower half of the pet carrier.

Quick release fasteners can be provided to secure the upper the upper and lower halves together. The fasteners comprise an upper handle connected to a lower contoured retainer with a shaft. The upper half includes an external flange having a bore sized to receive the shaft and the lower half includes an external flange having an opening sized to receive the retainer whereby the retainer is not able to come out of the upper half and whereby when the retainer is rotated away from the opening in the lower half, the retainer secures the lower half to the upper half.

The inventive pet carrier can include a gate assembly positioned on one end and between the upper and lower halves. The gate assembly comprises a pair of hinge assemblies. Each of the hinge assemblies comprises an upper and a lower extendible retaining rod. The upper and the lower retaining rods are biased outwardly. The upper retaining rod extends into a hole formed in an outer edge of the upper halve and the lower retaining rod extends into a hole formed in an outer edge of the lower half whereby the gate assembly can rotate about one of each of the hinge assemblies.

The pet carrier can include at least one retractable handle assembly that is positioned in a recess in the upper half of the pet carrier whereby the handle assembly remains flush with the outer surface of the upper half to avoid conflicting with other luggage or carriers during transport.

The pet carrier can also include a storage compartment molded into a recess in the upper half of the pet carrier whereby the storage compartment remains flush with the outer surface the upper half to avoid conflicting with other luggage or carriers during transport.

The inventive pet carrier creates surprising results because the completely smooth exterior surface that results from the inventive features, prevents the carrier from snagging or otherwise conflicting with other pet carriers, other freight or luggage or obstructions that may be encountered during transport to or from the aircraft. Furthermore, the smooth exterior that results from the inventive arrangement of components of the instant invention provides remarkable efficiency in the handling, mobility and storage of the pet carrier in and around the airport and the airplanes. The inventive pet carrier prevents the repeatedly snagging onto other carriers, other passengers luggage or on airline protuberances for which existing pet carriers are notorious.

### BRIEF DESCRIPTION OF THE DRAWINGS

FIG. 1 shows a perspective view of the inventive pet carrier with the wheels in a retracted position.

FIG. 2 shows a detail section view of the spring housing for the hinge assembly.

FIG. 3 shows a perspective view of the inventive pet carrier with the wheels in a deployed position and with the retractable handle in an extended position.

FIG. 4 is a detail section view of the retractable handle mount taken from line 4-4 of FIG. 3.

FIG. 5 is an enlarged view of the quick release fastener from FIG. 3.

FIG. 6 is a partial view of the inventive pet carrier showing details of one of the wheel assemblies in a downward, deployed position.

FIG. 7 is a detail section view of the sliding panel taken from line 7-7 of FIG. 6.

FIG. 8 is a detail section view of the sliding panel taken from line 8-8 of FIG. 6.

FIG. 9 is a partial sectional view of a wheel assembly shown in a secured, downward position taken from line 9-9 of FIG. 6.

FIG. 10 is a sectional view of a wheel support member taken from line 10-10 of FIG. 9.

FIG. 11 is a partial sectional view of a wheel assembly shown in an unsecured, rotating, downward position.

FIG. 12 is a sectional view of a wheel support member taken from line 12-12 of FIG. 11.

FIG. 13 is a partial isometric view of the wheel assembly in an unsecured, rotating upward position.

FIG. 14 is a partial sectional view of a wheel assembly shown in a secured, upward position.

FIG. 15 is a sectional view of a wheel support member taken from line 15-15 of FIG. 14.

### DETAILED DESCRIPTION OF THE INVENTION

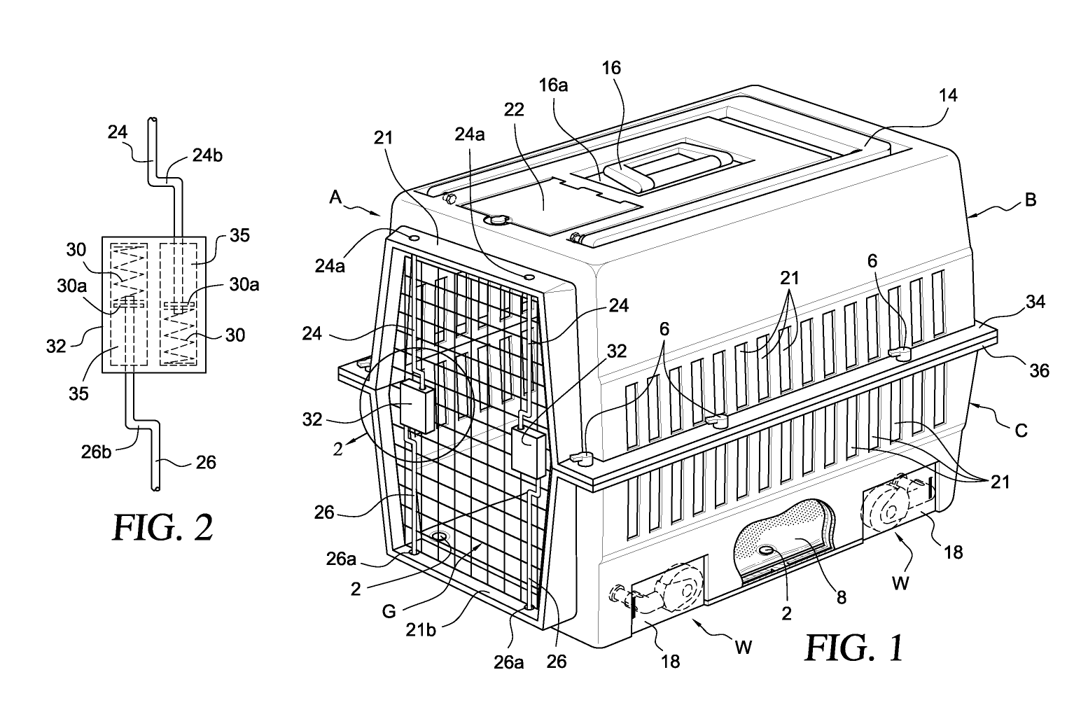

FIG. 1 shows the inventive pet carrier A. The pet carrier A includes features that are designed to provide a smooth outer surface so that the pet carrier A does not get stuck on, interfere with, or otherwise conflict with other objects or structures. The pet carrier includes an upper half B and a lower half C. The upper half B includes an external flange 34 and the lower half C includes an external flange 36. The external flange 34 of the upper half is secured to the external flange 36 of the lower half with quick release fasteners 6, to be described in more detail below.

Multiple vents 21 generally are provided in the upper half B and lower half C to provide ventilation to the pet.

A symmetric pair of hinge assemblies is provided. Each hinge assembly comprises a spring housing 32 (best seen in FIG. 2) in which a spring 30 is provided to urge the end of an upper retaining rod 24 into a hole 24a formed in an outer flange 21 of the upper half B. A spring 30 is also provided to urge the end of a lower retaining rod 26 into a hole 26a. The upper retaining rod 24 and lower retaining rod 26 can be released by pressing together on bend 24b and on bend 26b. Pressure on bend 24b imposes pressure on washer 30a to compress spring 30. Similarly, pressure on bend 26b imposes pressure on washer 30a to compress spring 30. When the bend 24b is pressed, the upper end of the upper retaining rod 24 retracts out of the retaining hole 24a and when the bend 26b is pressed, the lower end of the lower retaining rod 26 retracts out of the retaining hole 26a. When the upper end of the upper retaining rod 24 and the lower end of the lower retaining rod 26 have both been retracted from the retaining holes 24a, 26a, the gate is free to swing open. Because the two sets of hinge assemblies are substantially identically constructed, either the retaining rods 24, 26 of the leftmost hinge assembly can be released to open the door from the left or the retaining rods 24, 26 of the rightmost hinge assembly can be released to open the door from the right. The upper end of the upper retaining rod 24 can be kept flush with the outside of flange 21 and the lower end of the lower retaining rod 26 can be kept flush with the outside of flange 21b to maintain a smooth surface on the outside of each flange.

The top handle 16 can be used to carry the carrier A. The top handle 16 folds into recess 16a, which is typically molded into the upper half B of the carrier A.

A removable disposable or reusable moisture absorbent liner 8 is shown in the inner floor of the lower half C of the carrier A. The liner 8 is secured with snaps 2 or other securing means.

A storage compartment is covered by cover 22. The storage compartment is also typically molded into the upper half B of the carrier A. The storage compartment can be used to carry food or other pet supplies with the carrier A.

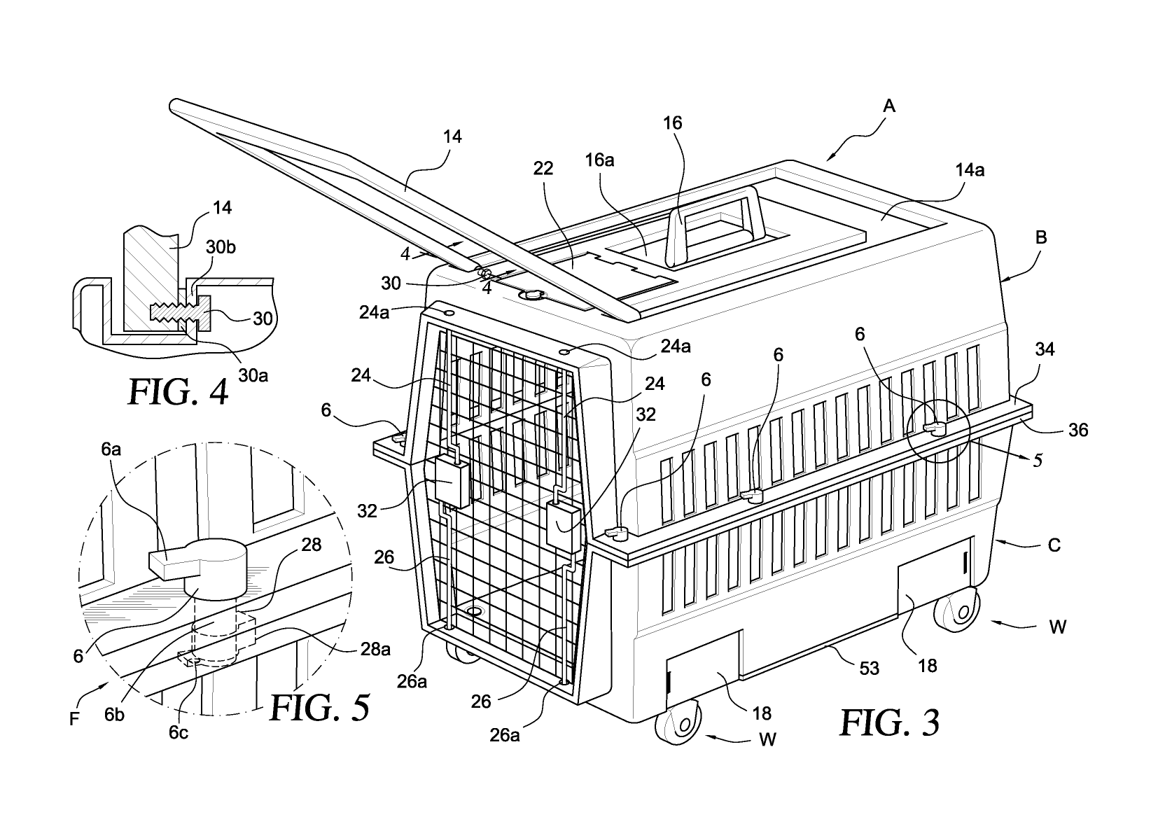

The retractable pull handle 14 rotates forward (FIG. 3) and is typically mounted to the upper half B of the carrier A with a bolt 30. A washer 30a is normally positioned outside of the pull handle 14 as shown in FIG. 4 to prevent binding between the pull handle 14 and the wall 30b of the upper half B of the carrier A. The retractable pull handle 14 is extended forward (FIG. 3) when the carrier A is to be pulled on the wheel assemblies W, to be discussed below.

In FIG. 5 a detail of a quick release fastener F is shown. A body 6 includes a tab 6a, which is used to grip the fastener F to rotate it when securing or separating the upper half B and lower half C of the carrier A. A bore 28 is provided in the flange 34 of the upper half B. Bore 28 is sized to accommodate the shaft 6b. An oblong opening 28a is shaped to allow the retaining tab 6c to pass through. Because the retaining tab 6c cannot pass through the bore 28, it causes the fastener F to stay secured in the upper flange of the top half B when the upper half B is separated from the bottom half C. When the retaining tab 6c has been inserted through the opening 28a, it can be rotated such that the retaining tab 6c is offset from the opening 28a thereby securing the flange 34 of upper top half B to the flange 36 of the lower half C.

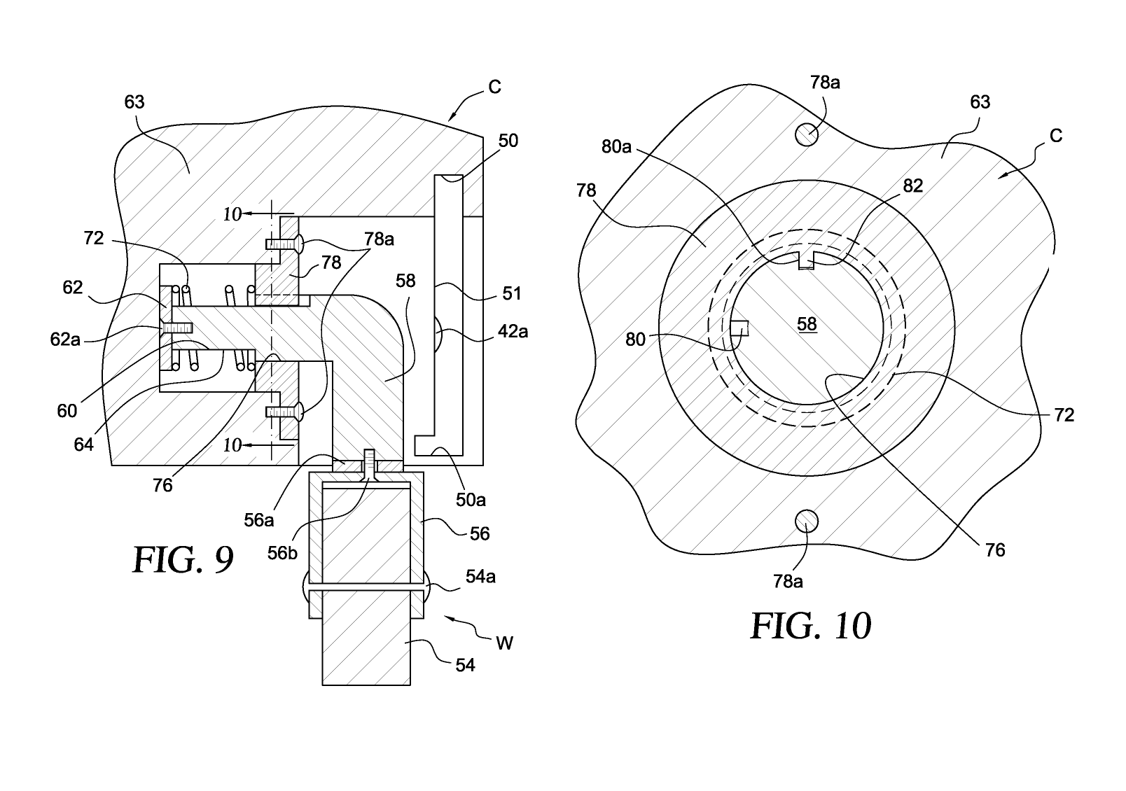

An enlarged view of the wheel assembly W is shown in FIG. 6. Typically there are four (4) wheel assemblies, uniformly positioned about the lower region of the lower half C of the carrier A. A wheel 54 is mounted to a wheel bracket 56 with an axle 54a. The wheel bracket 56 is mounted to a wheel support member 58 with a bolt 56b (best seen in FIG. 9) or other securing means. A washer 56a is typically installed between the wheel support member and the wheel bracket 56 to reduce friction during rotation of the wheel bracket 56 relative to the wheel support member 58. The wheel 54 and wheel bracket 56 can rotate on the bolt 56b relative to the wheel support member 58. It is contemplated that alternative roller wheels may be used, such as casters.

Referring now to FIG. 9, the wheel support member 58 includes a reduced diameter section 60 on which a spring 72 is assembled. The spring 72 is contained between the wall insert 78 and the spring retainer 62. The spring retainer 62 is attached to the end of the wheel support member with a bolt 62a or other securing means. The spring retainer may also be integral with the wheel support member 58.

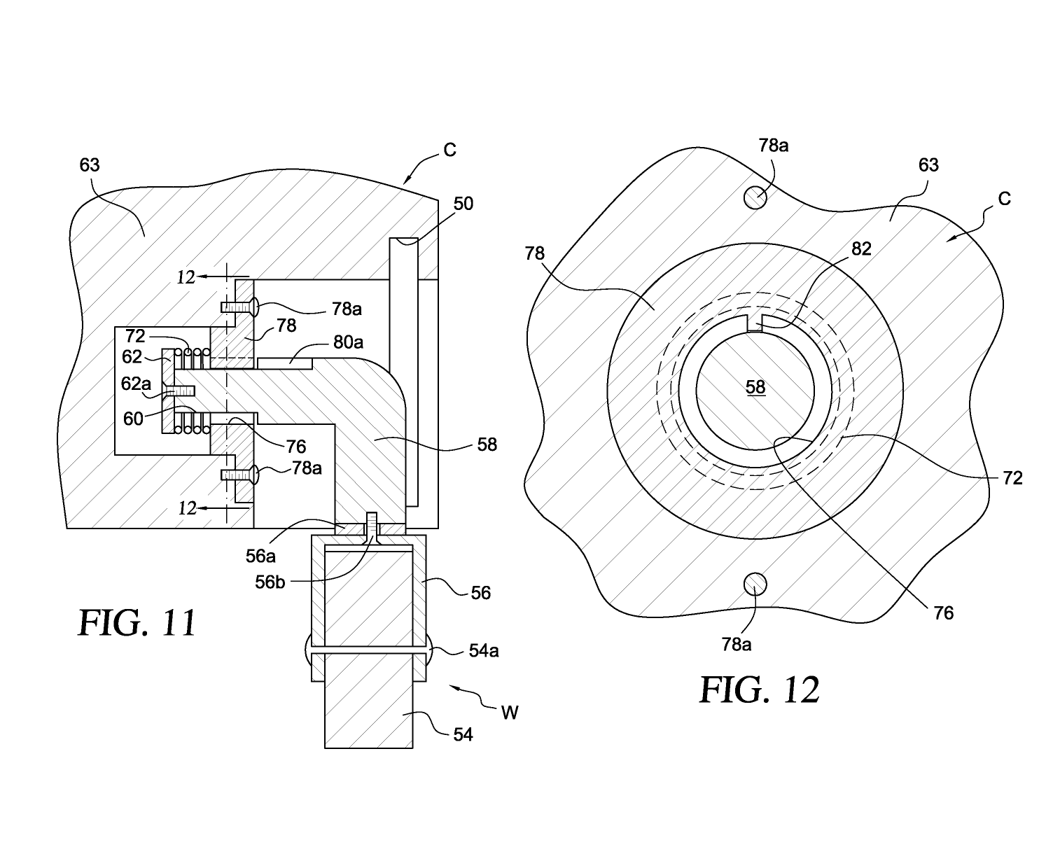

The wheel support member 58 includes at least two (2) slots 80, 80a, best seen in FIG. 10. Wall insert 78 is connected to the wall 63 of the lower half C of the carrier A with bolts 78a or other fastening means. The wall insert 78 is generally constructed of a metallic material or other desired material to withstand the forces transmitted from the wheel assemblies W. The wall insert 78 includes a key 82 on the interior surface as best seen in FIGS. 9-12. The wheel support member 58 can rotate to a downward, deployed position, as shown in FIGS. 9-12. When the wheel support member 58 is in the downward, deployed position, slot 80a engages key 82 to secure the wheel support member 58 and prevent it from rotating up or down.

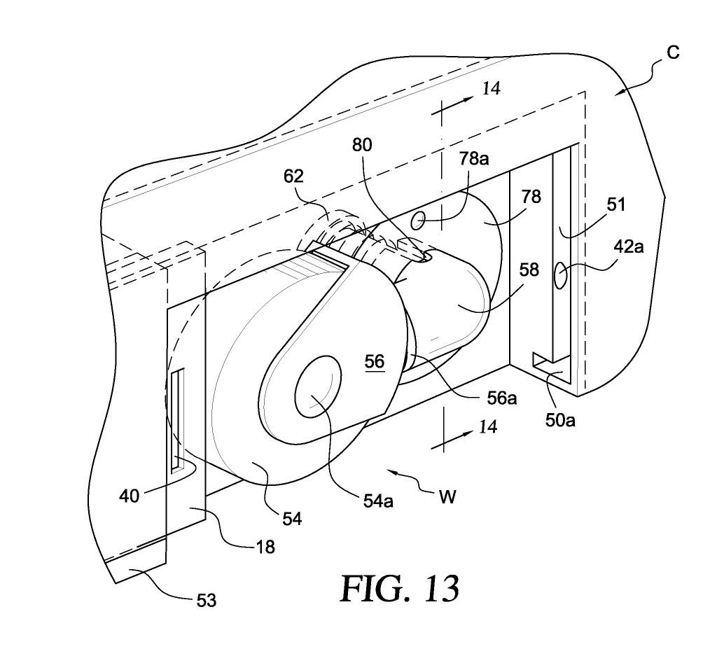

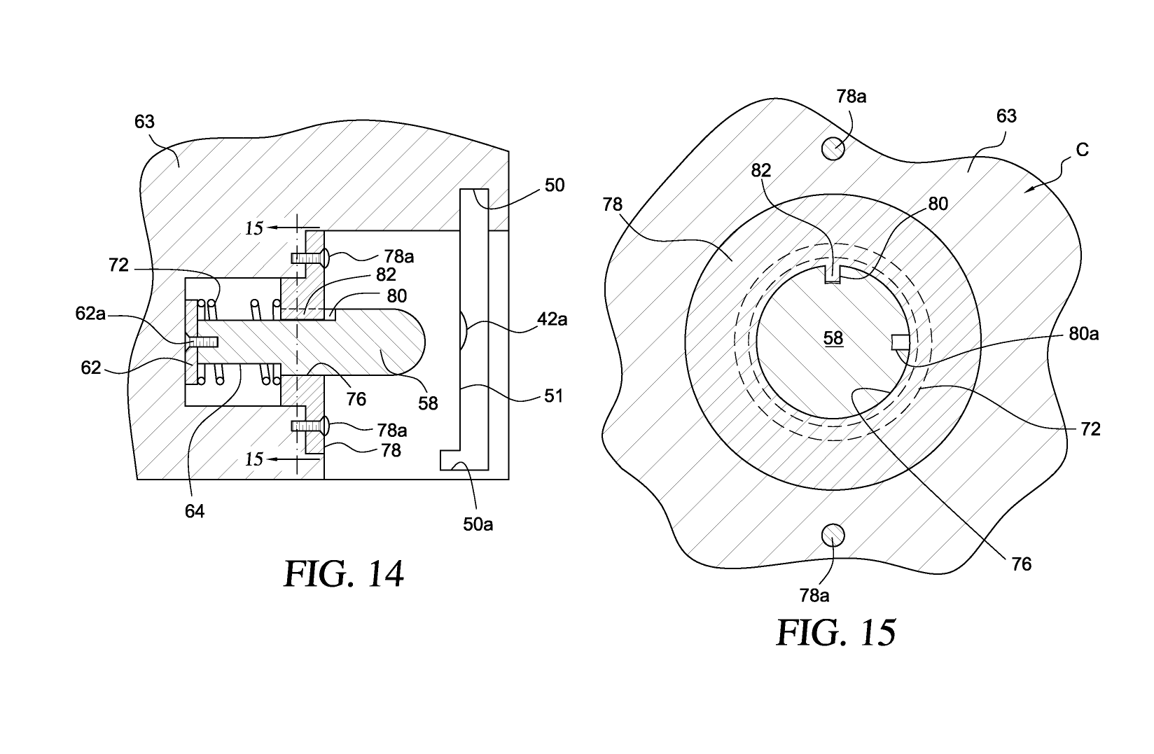

The wheel assembly W and the wheel support member 58 can be rotated to the upward stowed position (FIGS. 13-15) by first pulling the wheel support member 58 outwardly with sufficient force to overcome the compression force of the spring 72. The wheel support member 58 must be pulled sufficiently far from the wall insert 78 so that the slot 80a is disengaged from the key 82. Once the slot 80a is disengaged from the key 82, the wheel support member 58 can be rotated upwardly to the position where slot 80 is in alignment with key 82. The wheel support member 58 and wheel assembly W can be seen in the upward, stowed position in FIGS. 13-15. Note that spring 72 urges the wheel support member 58 inwardly to maintain engagement between the slot 80 or slot 80a and the key 82. The inward force imposed by spring 72 provides assurance that the wheel support member 58 and the wheel assembly W will remain sufficiently close to the wall insert 78 and inside of the panel 18.

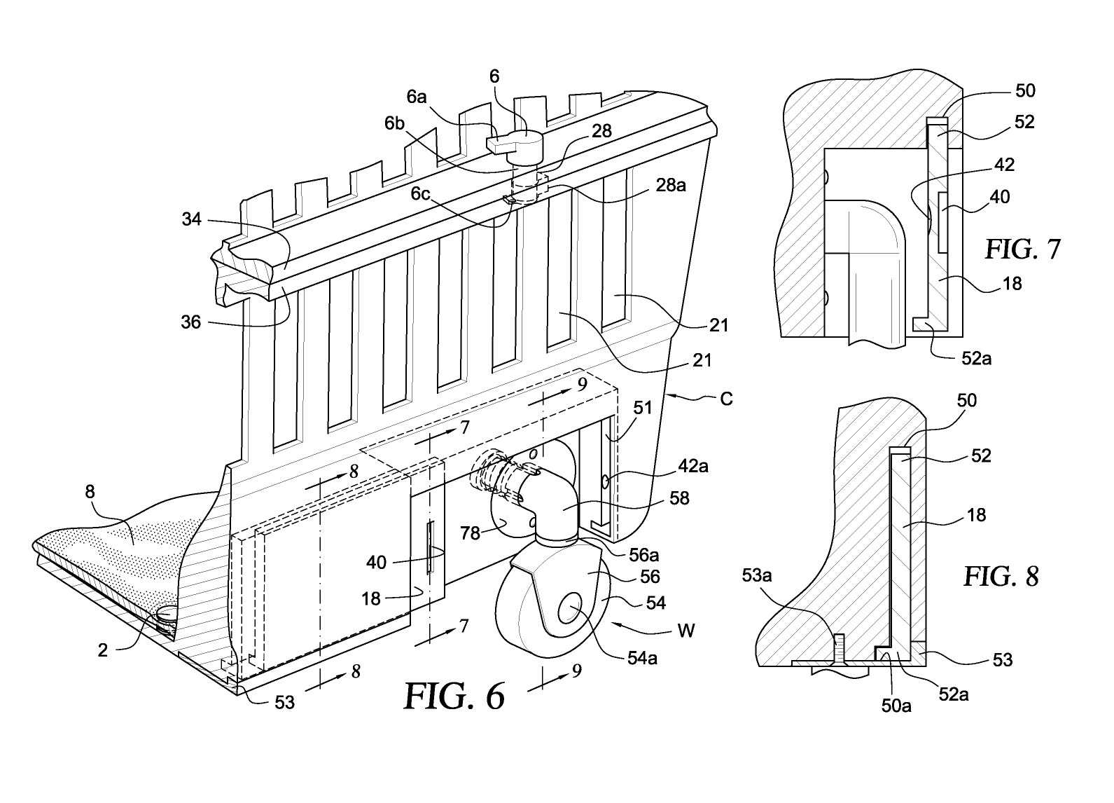

Referring to FIGS. 7 and 8, panel 18 is provided to conceal the wheel assembly W and to prevent each wheel assembly W from catching on other carriers, luggage, freight or other objects during. Panel 18 creates a smooth outer surface for the carrier A. Panel 18 typically has a flat section 52 at the top and an L-shaped section 52a at the bottom. The flat section 52 slides in slot 50 and the L-shaped section slides in L-shaped slot 50a. The panel 18 is retained within slots 50 and 50a with a retaining strip 53 (best seen in FIG. 8). Retaining strip 53 is secured to the bottom of the lower half C of the carrier A with bolts 53a or other securing means.

Panel 18 can be slid into a closed position when the wheels are in an upward, stowed position (FIG. 1) and when the wheels are in a downward, deployed position (FIG. 3). A recessed slot 40 is provided to provide finger engagement with the panel to slide it to an open or a closed position. A recess 42 (FIG. 7) of a generally oval or round shaped is provided on the inner surface of the panel 18. A protuberance 42a is positioned on the inner wall 51 between slot 50 and slot 50a. Protuberance 42a is approximately the same shape as recess 42 so that when the panel 18 is slid into the closed position, protuberance 42a engages recess 42 to keep the panel 18 securely closed.

The invention is not limited to the above-described embodiments and other embodiments may fall within the scope of the invention, the claims of which follow.

What is claimed is:

1. An airline compatible pet carrier comprising:
a. an upper and a lower half;
b. a plurality of wheels rotatably attached to substantially L-shaped rotatable wheel support members;
c. said rotatable wheel support members are mounted to a lower region of said lower half;
d. said lower region being proximate to a lower edge of said lower half;
e. said wheels being positioned within a recess in said lower region of said lower half; and
f. said rotating wheel support members being secured in an upward and a downward position whereby each of said wheels are alternately secured in an upward, stowed position and a downward, deployed position.

2. An airline compatible pet carrier according to claim 1 wherein a liner is removably secured to an inner floor said lower half.

3. An airline compatible pet carrier according to claim 1 wherein said upper and said lower halves are secured together with a plurality of rotating, quick release fasteners; said fasteners comprising an upper handle connected to a lower contoured retainer with a shaft; said upper half of said pet carrier includes an external flange having a bore sized to receive said shaft and said lower half of said pet carrier includes an external flange having an opening sized to receive said retainer whereby said retainer is not able to come out of said upper half and whereby when said retainer is rotated away from the opening in said lower half and whereby said retainer secures said lower half to said upper half.

4. An airline compatible pet carrier according to claim 1 comprising a gate assembly positioned on one end and between said upper and lower halves; said gate assembly comprising a pair of hinge assemblies; each of said hinge assemblies comprising an upper and a lower extendible retaining rod; said upper and said lower retaining rod being biased outwardly; said upper retaining rod extending into a hole formed in an outer flange of said upper halve and said lower retaining rod extending into a hole formed in an outer flange of said lower halve whereby said gate assembly can rotate about one of each of said hinge assemblies to open from the left hand or from the right hand direction.

5. An airline compatible pet carrier according to claim 1 comprising at least one retractable handle assembly positioned into a recess in said upper half of said pet carrier whereby said handle assembly remains flush with an outer surface of said upper half to avoid conflicting with other luggage or carriers during transport.

6. An airline compatible pet carrier according to claim 1 comprising a storage compartment molded into a recess in said upper half of said pet carrier whereby said storage compartment remains flush with an outer surface of said upper half to avoid conflicting with other luggage or carriers during transport.

7. An airline compatible pet carrier according to claim 1 wherein a panel is substantially flush with the outside of the lower half which covers each of said wheels whereby said wheels do not interfere with external objects during transit and whereby the exterior surface of the pet carrier is smooth.

8. An airline compatible pet carrier comprising:
a. an upper and a lower half;
b. a plurality of wheels rotatably attached to a lower region of said lower half;
c. said wheels being positioned within a recess in said lower region of said lower half;
d. said wheels being mounted on a rotating wheel support member;
e. said rotating wheel support members being secured in an upward and a downward position whereby each of said wheels are alternately secured in an upward, stowed position and a downward, deployed position;
f. a panel, substantially flush with the outside of the lower half covers each of said wheels whereby said wheels do not interfere with external objects during transit and whereby the exterior surface of the pet carrier is smooth.

9. An airline compatible pet carrier according to claim 8 comprising a gate assembly positioned on one end and between said upper and lower halves; said gate assembly comprising a pair of hinge assemblies; each of said hinge assemblies comprising an upper and a lower extendible retaining rod; said upper and said lower retaining rod being biased outwardly; said upper retaining rod extending into a hole formed in an outer flange of said upper halve and said lower retaining rod extending into a hole formed in an outer flange of said lower halve whereby said gate assembly can rotate about one of each of said hinge assemblies to open from the left hand or from the right hand direction.

10. An airline compatible pet carrier according to claim 8 wherein said upper and said lower halves are secured together with a plurality of rotating, quick release fasteners; said fasteners comprising an upper handle connected to a lower contoured retainer with a shaft; said upper half of said pet carrier includes an external flange having a bore sized to receive said shaft and said lower half of said pet carrier includes an external flange having an opening sized to receive said retainer whereby said retainer is not able to come out of said upper half and whereby when said retainer is rotated away from the opening in said lower half and whereby said retainer secures said lower half to said upper half.

11. An airline compatible pet carrier according to claim 8 comprising at least one retractable handle assembly positioned into a recess in said upper half of said pet carrier whereby said handle assembly remains flush with an outer surface of said upper half to avoid conflicting with other luggage or carriers during transport.

12. An airline compatible pet carrier according to claim 8 comprising a storage compartment molded into a recess in said upper half of said pet carrier whereby said storage compartment remains flush with an outer surface of said upper half to avoid conflicting with other luggage or carriers during transport.

13. An airline compatible pet carrier comprising:
a. an upper and a lower half;
b. a plurality of wheels rotatably attached to a lower region of said lower half;
c. said wheels being positioned within a recess in said lower region of said lower half;
d. said wheels being mounted on a substantially L-shaped rotating wheel support member;
e. said rotating wheel support members having a pin end which protrudes into a socket positioned in said recess of said lower region of said lower half; said pin ends of said wheel support members having a plurality of slots that engage at least one key in each of said sockets, wherein at least one of said slots engages said at least one key when said wheel support member is in an upward, stowed position and at least one of said slots of said pin end of said wheel support member engages another of said at least one key when said wheel support is in a downward, deployed position.

14. An airline compatible pet carrier according to claim 13 wherein each of said pin ends of said wheel support members includes a spring member on said pin end to urge said pin end of said wheel support member inwardly toward said recess of said lower region of said lower half of said pet carrier.

15. An airline compatible pet carrier according to claim 13 wherein said socket is integral with an insert that is secured to the lower half of said pet carrier.

16. An airline compatible pet carrier according to claim 13 wherein a sliding panel is provided outside of each of said recess to cover each of said wheels and each of said wheel support members whereby conflict between said wheels and said wheel support members with any external objects is prevented.

17. An airline compatible pet carrier according to claim 14 wherein a spring retainer is provided on a distal end of said pin to retain said spring on said pin whereby said spring is contained between said spring retainer and an interior surface of said lower half of said pet carrier.

18. An airline compatible pet carrier according to claim 13 wherein said upper and said lower halves are secured together with a plurality of rotating, quick release fasteners; said fasteners comprising an upper handle connected to a lower contoured retainer with a shaft; said upper half of said pet carrier includes an external flange having a bore sized to receive said shaft and said lower half of said pet carrier includes an external flange having an opening sized to receive said retainer whereby said retainer is not able to come out of said upper half and whereby when said retainer is rotated away from the opening in said lower half and whereby said retainer secures said lower half to said upper half.

19. A method of constructing an airline compatible pet carrier comprising the steps of:
a. providing an upper and a lower half;
b. attaching a plurality of wheels rotatably to a lower region of said lower half;
c. positioning said plurality of wheels in a recess in said lower region of said lower half;
d. mounting said wheels on a substantially L-shaped rotating wheel support member;
e. including a pin end on said wheel support members that protrudes into a socket positioned in said recess of said lower region of said lower half;
f. providing a plurality of slots in said pin ends of said wheel support members for engaging at least one key in each of said sockets, whereby at least one of said slots engages said at least one key when said wheel support member is in an upward, stowed position and at least one of said slots of said pin end of said wheel support member engages another of said at least one key when said wheel support is in a downward, deployed position.

20. A method of constructing an airline compatible pet carrier according to claim 19 comprising the additional step of including a spring member on said pin end of said wheel support member to urge said pin end of said wheel support member inwardly toward said recess of said lower region of said lower half of said pet carrier.
